(19) United States
(12) Patent Application Publication
(10) Pub. No.: US 2003/0191417 A1
(43) Pub. Date: Oct. 9, 2003

(54) Gum massager device

(75) Inventors: Theodore Welt, Jerusalem (IL); Jonathan H. Weisberg, Jerusalem (IL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Verifresh Ltd., Jerusalem (IL)

(21) Appl. No.: 10/390,047

(22) Filed: Mar. 17, 2003

Related U.S. Application Data
(60) Provisional application No. 60/370,258, filed on Apr. 8, 2002.

(51) Int. Cl. A61H 7/00; A61H 21/00

(52) U.S. Cl. 601/134; 601/138; 601/141; 601/142

(57) ABSTRACT

There is provided a gum massager, which includes an elongate handle member having a first free end portion and a second end portion. The gum massager also includes a massaging head member formed together with the second end portion of the elongate handle member. The massager head member includes a resilient massaging element formed so as to generally adapt to the contours of a gum portion being massaged, when pushed thereagainst.

### FIELD OF THE INVENTION

The present invention relates to a gum massager device.

### BACKGROUND OF THE INVENTION

It is known in the art to provide gum-massaging instruments of various kinds.

Referring now to U.S. Pat. No. 4,220,144 to Balais on Sep. 2, 1980 entitled “Oral Hygiene Device.” There is disclosed an oral hygiene device to be secured to a first end section. A gingivae massage element is secured to a second end section of the toothbrush. The massage element substantially defines a chordal segment of a cylindrical contour which has an arcuate contour outer surface for compressively interfacing with the gingivae of a user. The gingivae massage element includes a planar chordal surface which is secured to the second end section of the toothbrush. In this manner, the gingivae massage element is compressively and deformably pressed against the gingivae lining during a massaging motion with a minimization of the possibility of injury to the tissue through any force application.

Referring now to U.S. Pat. No. 4,299,208 to Blanc on Nov. 10, 1981, entitled “Gum Massage Device” there is disclosed a gum massage device adapted to be inserted on a handle and having a longitudinally extending passage containing an intermediate interlocking enlarged formation to provide a resilient cushion for the gum massaging action and interlocking enlarged formations on each side of the intermediate formation.

Referring now to U.S. Pat. No. 4,347,839 to Youngclaus, Jr. on Sep. 7, 1982 entitled “Gum Massage Device” there is disclosed a gum massage device, which includes a soft tipped wand, connected to a power unit. The power unit has a rotary shaft that is engaged in a socket in the base of the wand. The socket is angularly offset from the normal axis of the shaft and wand, and a member is connected between the wand and power unit to resiliently hold the shaft and wand in axial alignment. Rotation of the shaft caused the wand to oscillate in a desirable gum massaging motion.

Referring now to U.S. Pat. No. 4,403,623 to Mark on Sep. 13, 1983 entitled “Combined Toothbrush And Gum Massage Device” there is disclosed a dental hygiene device for toothbrushing and gum massage that comprises an elongated handle on which a bristle carrying head is pivotable for movement between a first operating position in alignment with the length of the handle and a second operating position at right angles to the length of said handle, there being a rib and groove arrangement for locking the head in either of those positions during normal toothbrushing and/or gum massaging operations but being readily responsive to torque applied by a user to turn the head from one position to another. The head has a central area of tooth engaging hard bristles, with areas of softer bristles at the ends for effective gum massaging.

Referring now to U.S. Pat. No. 4,585,416 to DeNiro, et al. on Apr. 29, 1986 entitled “Device For Cleaning Teeth And Massaging Gums” there is disclosed a device for simultaneously cleaning teeth, cheeks, lips and the tongue and massaging gums. The device is placed between the teeth and operates in response to chewing action. It can optionally be used with a dentifrice.

Referring now to U.S. Pat. No. 5,119,803 to Fishman on Jun. 9, 1992 entitled “Disposable Medicinal Applicator and Gum Massage Tip” there is disclosed a disposable medicinal applicator tip of the type for use on a handheld gum massaging tool, the applicator tip being specifically adapted to carry a charge of medicament so that when the tip is moved over the gum area, the gums are massaged while the tip simultaneously delivers the medicament to the gums and surrounding area providing necessary topical treatment at the sight of gum disease.

Referring now to U.S. Pat. No. 6,141,818 to Weihrauch on Nov. 7, 2000 entitled “Brush For Gum Massage And Tooth Cleaning And Process For Producing The Bristles Of Such A Brush”there is disclosed a gingival massaging and tooth cleaning brush, which comprises a bristle carrier with handle and on the bristle carrier individual or bundlewise fixed plastic bristles. For improving the massaging action the bristles are waved transversely to their axis, accompanied by the formation of distinct, stud-like wave tops and with a short wave length.

Referring now to U.S. Pat. No. 6,311,358 to Soetewey, et al. on Nov. 6, 2001 entitled “Toothbrush Comprising Gum-Massaging Sticks” there is disclosed a toothbrush including a head, which is placed at a front longitudinal end of a handle. The head is equipped, on an upper face, with a bunch of parallel filaments and a series of rods made from elastomer material. These rods extend substantially parallel to the filaments and are placed with one row on each side of the bunch of filaments. Each row of rods includes tall rods, arranged longitudinally substantially in the center of the row. The length of the rows is longer than the length of the adjacent filaments and short rods which are arranged at the ends of the row and the length of which is shorter than the length of the adjacent filaments.

The above-cited references disclose manually and electrically operated gum-massaging instruments, or combined toothbrush-and-gum massagers.

The main disadvantage of most existing gum massaging instruments, including the above-mentioned types, resides in their basic inappropriate construction. These instruments do not satisfactorily fulfill their task. These manually operated toothbrush-type massagers do not properly cover and touch, in a uniform and consistent manner, the entire surface portions of the gums. Hence these instruments do not efficiently and effectively massage the gums. Furthermore, none operate at an optimal angle for the purpose of massaging the gums. The final result is a highly disproportionate activation of the gums in the vicinity of the teeth. Relative to the rest of the gum surface, extending towards the roots of the teeth, there is a danger of damaging the delicate tissue inside the mouth. Another shortcoming of the prior art gum massaging instruments resides in the fact that they do not provide a sufficient means for controlling the pressure on the gum surface. The consequence is uneven massage application and pressure distribution over the entire surface of human gums.

### SUMMARY OF THE INVENTION

The present invention aims to provide a gum massager having an optimized ergonomic structure and an improved massaging capability and efficiency. The consequence is a device, which enables the user to take advantage of the improved ergonometric design of both the device handle and the actual massaging head. The massaging head is configured to be comfortably positioned and moved along the inner and outer gum surfaces inside the mouth so as to apply an optimal massage to the gums.

According to a preferred embodiment of the present invention, there is provided a gum massager, which includes an elongate handle member having a first free end portion and a second end portion. The gum massager also includes a massaging head member formed together with the second end portion of the elongate handle member. The massager head element includes a resilient massaging element formed so as to generally adapt to the contours of a gum portion being massaged, when pushed thereagainst.

According to a first embodiment of the present invention, the gum massager, including the elongate handle member, has one or more ergonometrically formed hand-hold elements formed integrally with the first end portion of the elongate handle member thereby to facilitate controlled movement of the massaging head member.

According to a second embodiment of the present invention, the second end portion of the elongate handle member has a predetermined shape configured to provide effective positioning of the massaging head member on gum surfaces, and to facilitate apply controlled pressure while massaging the gums.

According to a third embodiment of the present invention, the predetermined shape of the second end portion of the elongate handle member is formed having a predetermined curvature to facilitate the massaging head member applying oscillating movements over the surface of the gums, and to follow the natural anatomic contour of the human denture when massaging the gum area with the elongate handle member maintained substantially parallel to the denture.

According to a fourth embodiment of the present invention, the predetermined shape of the second end portion of the elongate handle member is formed having a predetermined cross-sectional shape thereby to impart flexibility and strength to the second end portion. The predetermined cross-sectional shape includes one or more cross-sectional shapes including elliptical, circular or a preselected geometric shape.

According to a fifth embodiment of the present invention, the first end portion of the elongate handle member is formed having an attachment means, thereby to attach the gum massaging device to a preselected elongate handle member.

According to a sixth embodiment of the present invention, the elongate handle member is formed so as to facilitate attachment of the gum massager to an electrically driven oscillatory device such that the oscillatory device provides an oscillatory movement to the massaging head member.

According to a seventh embodiment of the present invention, the massaging portion of the resilient massaging element is generally configured as a bell shape, having a recessed inner surface terminating in an outer lip. The outer lip element is formed having a curved outer edge.

According to a variation of the seventh embodiment of the present invention, the bell-like resilient massaging element is divided into a predetermined number of separate segments.

According to other variations of the seventh embodiment of the present invention, the resilient massaging element includes one or more resilient protrusions extending from the recessed inner surface so as to improve the massaging contact thereof on the gums. The one or more resilient protrusions include a plurality of protrusions. The one or more resilient protrusions includes one or more protrusions having a shape that is cylindrical, tubular or of a predetermined geometric shape, or is disposed transversely across the recessed inner surface of the resilient massaging element.

According to a further variation of the seventh embodiment of the present invention, the outer lip element is formed so as to have a predetermined resilience thereby to provide a suction effect on the gum surface to stimulate the gums.

According to an eighth embodiment of the present invention, the massaging head member is flexibly secured to the second end portion of the elongate handle member thereby to facilitate limited oscillation movement of the head member relative to the elongate handle member so as to cause the massaging portion of the massaging head member to maintain contact with the natural contours of the gum surface.

### BRIEF DESCRIPTION OF THE DRAWINGS

The present invention will be more fully understood and its features and advantages will become apparent to those skilled in the art by reference to the ensuing description, taken in conjunction with the accompanying drawings, in which:

FIG. 1 illustrates a head-on view of a gum massager in accordance with a preferred embodiment of the present invention;

FIG. 2 illustrates a side view of the gum massager of FIG. 1;

FIG. 3 illustrates a plan view of the gum massager of FIG. 1;

FIG. 4 illustrates a cross-sectional view of a gum massaging head member formed together with a second end portion of an elongate handle member;

FIGS. 5 and 6 illustrate the gum massaging head member of FIG. 4 indicating oscillation movements relative to elongate handle member;

FIGS. 7 and 8 illustrate, according to alternate embodiments of the present invention, elliptical gum massaging head members;

FIGS. 9 and 10 illustrate, according to other embodiments of the present invention, rib protrusions disposed within massaging head members;

FIGS. 11 and 12 illustrate, according to further embodiments of the present invention, elliptical shaped protrusions formed within massaging head members;

FIGS. 13 and 14 illustrate, according to further embodiments of the present invention, concentric protrusions disposed within massaging head members;

FIGS. 15 and 16 illustrate replaceable gum massager heads, in accordance with alternative embodiments of the present invention;

FIG. 17 illustrates a gum massaging head member having perforations formed on the bell shaped lateral sides thereof;

FIG. 18 illustrates a gum massaging head member having openings formed in the bell shaped lateral sides thereof;

FIG. 19 illustrates, according to another embodiment of the present invention, a gum massager having a first portion of an elongate handle member so formed to fasten an elongate toothbrush handle member thereto;

FIG. 20 illustrates, according to an added embodiment of the present invention, a gum massager head and a toothbrush head disposed at opposite ends of an elongate handle member;

FIG. 21 illustrates, according to another embodiment of the present invention, a gum massager head and a tongue cleaner device head disposed at opposite ends of an elongate handle member; and

FIG. 22 illustrates attachment of a gum massager to an electrically driven oscillatory device.

### DETAILED DESCRIPTION OF THE INVENTION

In order to properly and effectively massage the inner and outer gum surfaces without causing injury as a result of applying excessive pressure, it is necessary that a gum massager device be correctly and ergonomically designed. Accordingly, the means for holding the massager device and the actual massaging element of the present invention are designed for the user to easily grasp the device and to apply a delicate massaging motion and pressure to the inner and outer gum surfaces, without causing undue abrasion or other injury to any part of the gums.

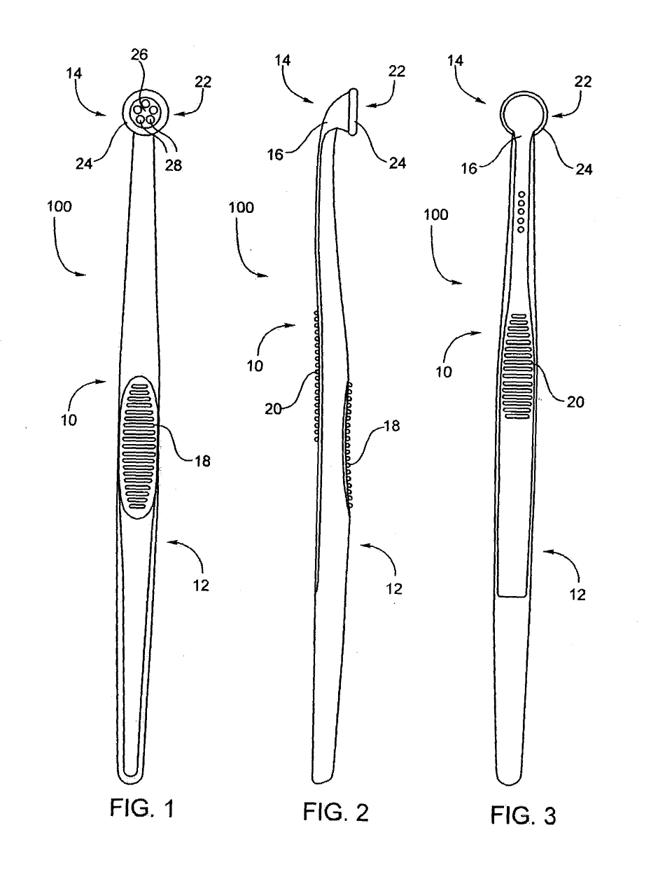

With reference to FIGS. 1-3, there are seen various views of a gum massager generally referenced 100, in accordance with a preferred embodiment of the present invention. Gum massager 100 includes an elongate handle generally referenced 10 having a free first end portion generally referenced 12 and a second end portion generally referenced 14 including a curved neck portion referenced 16. There are two ergonometrically formed handhold elements referenced 18 and 20 formed integrally with first end portion 12 of elongate handle member 10.

Gum massager 100 also includes a massaging head member generally referenced 22, formed together with second end portion 14 of elongate handle member 10 and bonded thereto. Massaging head member 22 is formed of a resilient rubber or plastic material and formed generally having a bell shape having a recessed inner surface terminating in an outer lip referenced 24. Resilient protrusions referenced 28 are formed extending from recessed inner surface 26 so as to improve the massaging contact thereof on the gums.

The ergonomics of the gum massager 100 have been optimized in such a way that:

1. The distance from the end of ridge of the user's thumb to the active tip or second end portion 14 of gum massager 100 are the average length of one side of the structure of the human gum, therefore allowing the user to massage the gums around the rearmost teeth in the mouth.

2. If seen from the side, as seen in FIG. 2, curved neck portion 16 of gum massager 100 is curved in order to follow the natural anatomic contour of the human denture. Therefore, when massaging the most remote gum areas, elongate handle member 10 remains generally parallel to the denture, and curved neck portion 16 maintains some distance between elongate handle member 10 and the dentures without affecting functionality.

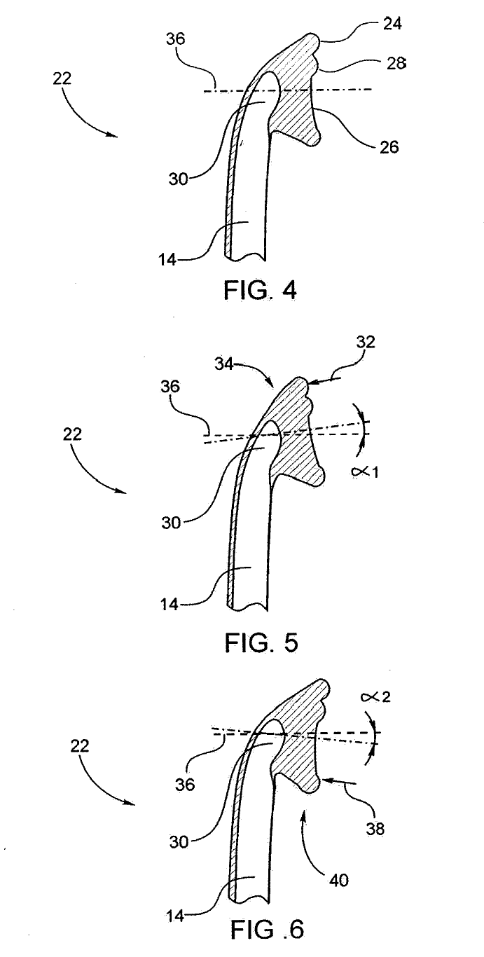

3. Curved neck portion 16 is formed with a progressive flexibility needed in order to prevent excessive pressure being applied to the gums while in use. This progressive flexibility of curved neck portion 16 is regulated through the cross-sectional geometry of curved neck portion 16, which becomes progressively thinner towards its extremity 30 (as disclosed hereinbelow in relation to FIG. 4).

4. The cross-sectional shape of curved neck portion 16 is generally elliptical not only for safety, having no sharp edges, but also to have an optimum compromise between the necessary strength needed in curved neck portion 16 and the need to minimize the net width of curved neck portion 16 while in use.

5. Handhold element 18 for the user's thumb is positioned generally facing the same direction as massaging head member 22, disposed on first free end 12 of elongate handle member 10. Handhold element 20 for the user's index and other fingers is positioned generally facing the opposite direction to massaging head member 22, so disposed on first free end 12 of elongate handle member 10, to allow for better control and balance while manipulating gum massager 100.

6. Massaging head member 22, is formed having a generally bell shape, and is attached by means of either a chemical bond or a mechanical bond to extremity referenced 30 (as disclosed hereinbelow in relation to FIG. 4) of second end 14 of elongate handle member 10. Massaging head member 22 is disposed at an angle of substantially 90 degrees relative to the axis of extremity 30.

7. Massaging head member 22 is formed having sufficient thickness to cause it to be compressible so that during use, the sensation is not only pleasant, soft and spongy, but also firm enough to provide effective massaging to the tissue of the gums without scratching or causing any injury thereto. Massaging head member 22 is formed having a thickness, which is a compromise, such that the cross-sectional area of lip referenced 24 is of a minimal thickness, thereby to avoid redundant thickness, which may bother the user.

8. Massaging head member 22 is formed so that during use, a slight suction is created, which increases the effectiveness of the contact between massager head member 22 and the gums. This affect brings the blood to the surface of the gums more effectively than simple physical massaging.

9. Massaging head member 22 is formed and attached to extremity 30 (FIG. 4) of second end 14 of elongate handle member 10 such that massaging head 22 is able to oscillate slightly relative to extremity 30 of elongate handle member 10 while in use (As disclosed hereinbelow in relation to FIGS. 4-6). This enables the lip surface 24 of massaging head member 22 to follow the natural contour of the surface of the gums while in use.

The “USE” is defined as causing massaging head member 22 to make a series of movements describing small circles or straight oscillating movements over the surface of the gums, while applying moderate pressure on the tissue of the gums.

10. Massaging head member 22 may have one or several cylindrical protrusions 28 (as disclosed hereinabove in relation to FIGS. 1-3), one or more transverse ribs 74 (as disclosed hereinbelow in relation to FIG. 9) or other protrusions formed therein so as to enhance the massaging effect, and also to enable more flexibility of the active area as opposed to a planar surface which would be less resilient and hence much less effective. To further improve and to maximize the massaging effect, as well as for enhanced safety, lip surface 24 of massaging head member 22 is formed having a rounded edge.

Referring now to FIG. 4 there is seen a cross-sectional view of a massaging head member 22 formed together with extremity 30 of second end portion 14 of an elongate handle member 10. Protrusions 28 are formed in recessed inner surface 26 and disposed within lip 24. Extremity 30 has a normal axis referenced 36.

Referring now to FIGS. 5 and 6 there is seen massaging head member 22 of FIG. 4, indicating oscillation movements relative to extremity 30. In FIG. 5, there is seen a force exerted as indicated by arrow referenced 32 on a distal portion generally referenced 34 of massaging head member 22 which causes massaging head member 32 to resiliently oscillate by angle α₁ relative to normal axis 36 of extremity 30 of second end portion 14 of elongate handle member 10. In FIG. 6, there is seen a force exerted as indicated by arrow referenced 38 on a proximal portion generally referenced 40 of massaging head member 22 which causes massaging head member 22 to resiliently oscillate by angle α₂ relative to normal axis 36 of extremity 30 of second end portion 14 of elongate handle member 10.

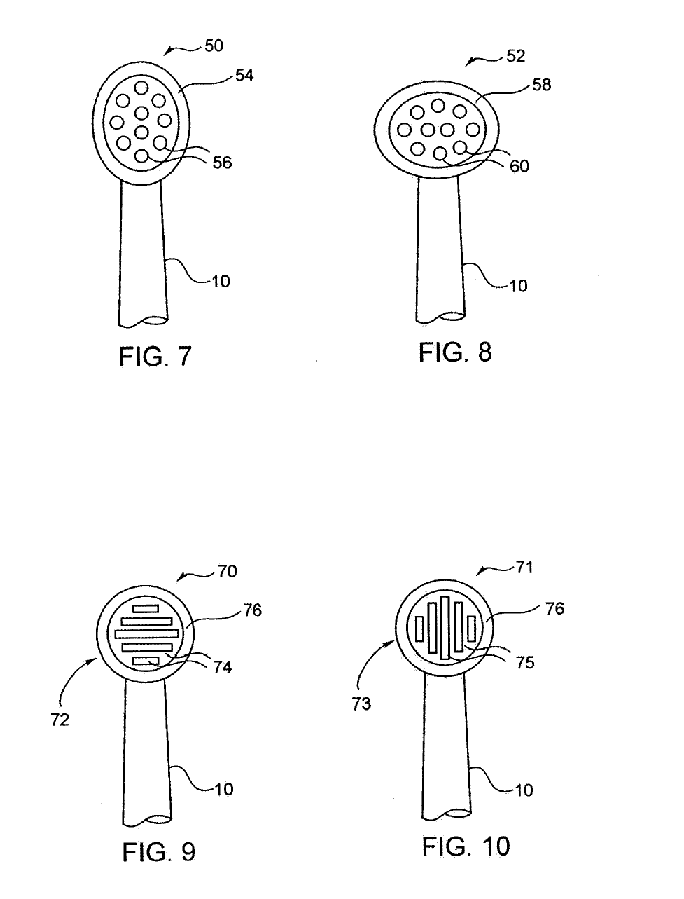

Referring now to FIGS. 7 and 8, there is seen, according to alternate embodiments of the present invention, elliptical gum massaging head members generally referenced 50 and 52 respectively. In FIG. 7, elliptical massaging head member 50 has an elliptical lip referenced 54 and protrusions referenced 56 formed therein. Elliptical gum massaging head member 50 is disposed with its minor elliptical axis (not shown) transverse to longitudinal axis of elongate handle member 10. In FIG. 8, elliptical massaging head member 52, having an elliptical lip referenced 58 and protrusions 60 formed therein, is disposed with its major elliptical axis (not shown) transverse to longitudinal axis of elongate handle member 10.

Referring now to FIG. 9, there is seen a massaging head member generally referenced 70, having disposed therein protrusions generally referenced 72, formed as transverse ribs referenced 74 disposed within lip referenced 76, such that ribs 74 are transverse to elongate handle 10. Referring now to FIG. 10, there is seen a massaging head member generally referenced 71, having disposed therein protrusions generally referenced 73, formed as longitudinal ribs referenced 75 disposed within lip 76 such that ribs 75 are formed longitudinal to elongate handle 10.

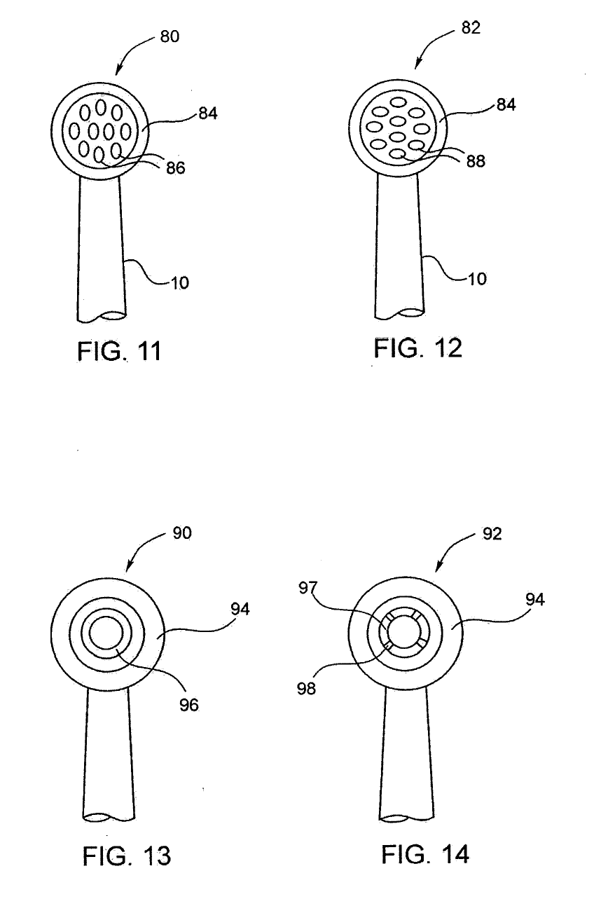

Referring further to FIGS. 11 and 12, there are seen massaging heads generally referenced 80 and 82 respectively. In accordance with an alternative embodiment of the present invention, in FIG. 11, there are formed within lip referenced 84 elliptical shaped protrusions referenced 86, having their minor axis (not shown) transverse to longitudinal axis (not shown) of elongate handle member 10. In accordance with another embodiment of the present invention, in FIG. 12, there are formed within lip 84 elliptical shaped protrusions referenced 88, having their major axis (not shown) transverse to longitudinal axis (not shown) of elongate handle member 10.

Referring now to FIGS. 13 and 14, there are seen massaging heads generally referenced 90 and 92 respectively. In FIG. 13, massaging head 90 has disposed within lip referenced 94 a concentric cylindrical protrusion referenced 96. In FIG. 14 massaging head 92 is formed having a concentric cylindrical protrusion referenced 97 formed within lip 94 such that cylindrical protrusion 97 is separated into segments by perforations referenced 98 formed therein.

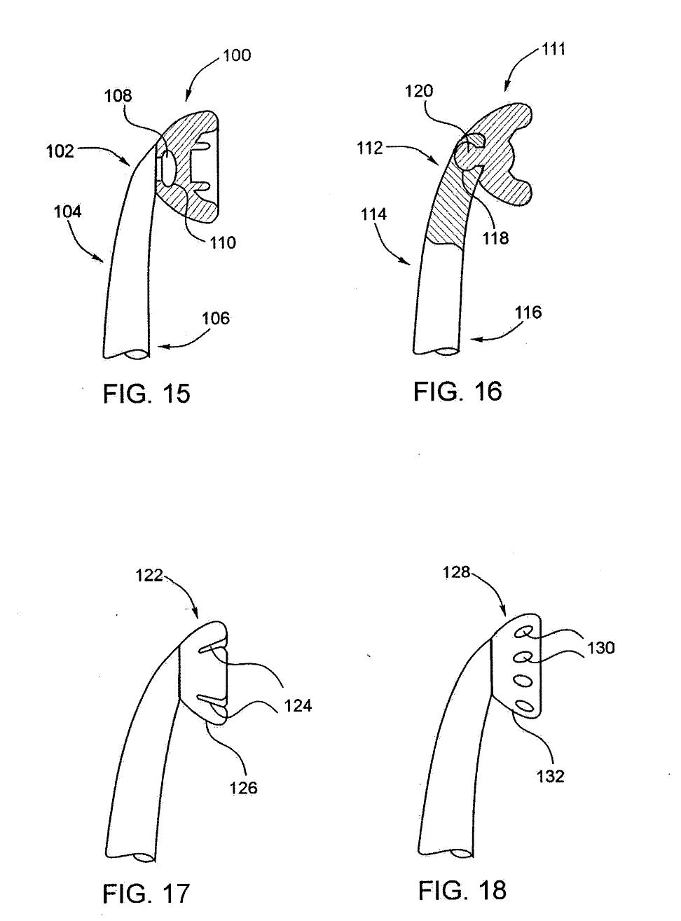

Referring now to FIG. 15, there is seen a replaceable gum massager head, generally referenced 100, removably attached to extremity generally referenced 102 of second portion generally referenced 104 of elongate handle member referenced 106. Extremity 102 is formed having a ball shaped portion referenced 108, which press-fits into a corresponding shaped socket referenced 110 formed in gum massager head 100. Apart from providing a replaceable gum massaging head 100, there is also provided a limited oscillation of gum massager head 100 relative to elongate handle member 106 by virtue of the ball-and-socket connection 108 and 110 respectively.

Referring now to FIG. 16, there is seen a replaceable gum massager head, generally referenced 111, removably attached to extremity generally referenced 112 of second portion generally referenced 114 of elongate handle member referenced 116. Extremity 112 is formed having a socket-shaped portion referenced 118, into which there is press-fitted a corresponding ball portion referenced 120 formed on gum massager head 111. Apart from providing a replaceable gum massaging head 111, there is also provided a limited oscillation of gum massager head 111 relative to elongate handle member 116 by virtue of the ball-and-socket connection 120 and 118 respectively.

Referring now to FIG. 17, there is seen a gum massaging head member, generally referenced 122, according to another embodiment of the present invention, having perforations referenced 124 formed in bell shaped lateral sides referenced 126 thereof.

Referring now to FIG. 18, there is seen a gum massaging head member generally referenced 128, according to a further embodiment of the present invention, having openings referenced 130 formed on the bell shaped lateral sides referenced 132 thereof.

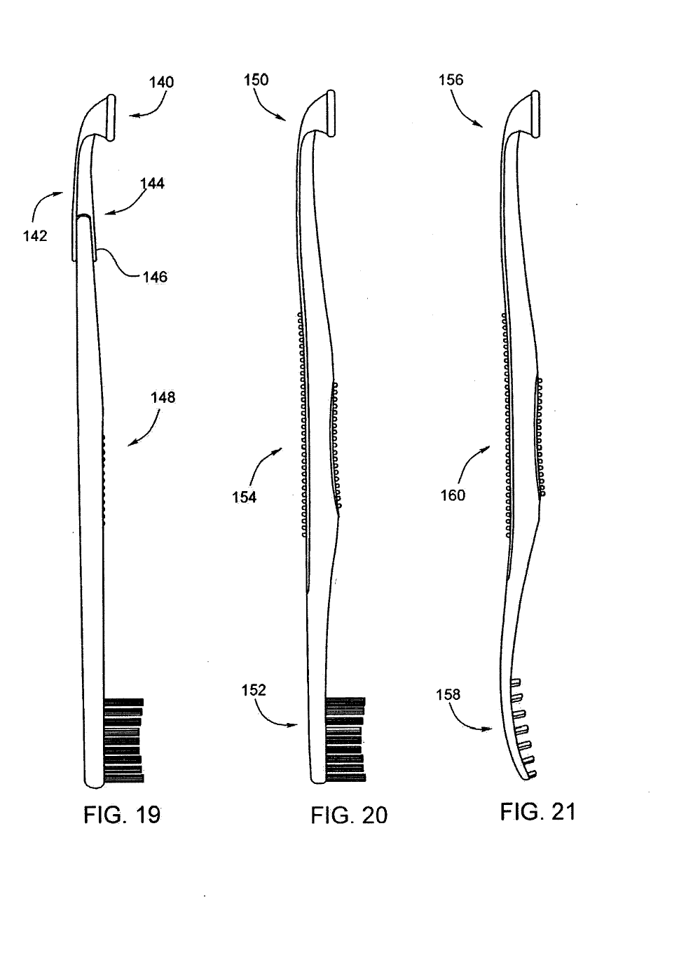

Referring now to FIG. 19, according to another embodiment of the present invention, there is seen a gum massager generally referenced 140 having a first portion referenced 142 of an elongate handle member referenced 144 formed having a socket portion referenced 146 disposed at first portion 142 thereof, so as to fasten gum massager 140 to an elongate toothbrush handle member generally referenced 148.

Referring now to FIG. 20, according to an embodiment of the present invention, there is seen a gum massager head generally referenced 150 and a toothbrush head generally referenced 152 disposed at opposite ends of an elongate handle member referenced 154.

Referring now to FIG. 21, according to an embodiment of the present invention, there is seen a gum massager head generally referenced 156 and a tongue cleaner device generally referenced 158 disposed at opposite ends of an elongate handle member referenced 160.

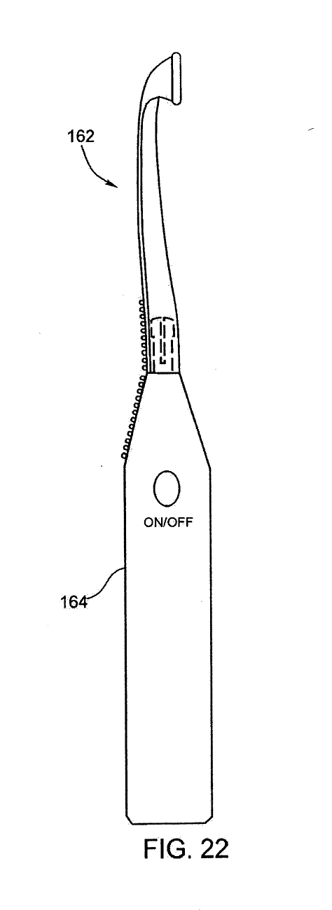

Referring now to FIG. 22, there is seen a gum massager generally referenced 162, according to one other embodiment of the present invention, detachably connected to an electrically driven oscillatory device referenced 164, which provides an oscillatory movement to gum massager 162 in contact with the user's gum surface.

It will be appreciated by persons skilled in the art that the present invention is not limited by the drawings and description hereinabove presented. Rather, the invention is defined solely by the claims that follow.

What is claimed is:

1. A gum massager which includes:
a) an elongate handle member having a first free end portion and a second end portion; and
b) a massaging head member formed together with said second end portion of said elongate handle member, and which includes a resilient massaging element formed so as to generally adapt to the contours of a gum portion being massaged, when pushed thereagainst.

2. A gum massager according to claim 1, wherein said elongate handle member has at least one ergonometrically formed hand-hold element formed integrally with said first end portion of said elongate handle member thereby to facilitate controlled movement of said massaging head member.

3. A gum massager according to claim 1, wherein said second end portion of said elongate handle member has a predetermined shape configured to provide effective positioning of said massaging head member on gum surfaces and to facilitate applying controlled pressure to the gums while massaging the gums.

4. A gum massager according to claim 3, wherein said predetermined shape of said second end portion of said elongate handle member is formed having a predetermined curvature to facilitate said massaging head member applying oscillating movements over the surface of the gums and following the natural anatomic contour of the human denture when massaging the gum area with said elongate handle member maintained substantially parallel to the denture.

5. A gum massager according to claim 3, wherein said predetermined shape of said second end portion of said elongate handle member is formed having a predetermined cross-sectional shape thereby to impart flexibility and strength to said second end portion.

6. A gum massager according to claim 5, wherein said predetermined cross-sectional shape includes at least one cross-sectional shape selected from the list of
a) elliptical;
b) circular; and
c) a preselected geometric shape.

7. A gum massager according to claim 1, wherein said first end portion of said elongate handle member is formed having an attachment means, thereby to attach said gum massager to said preselected elongate handle member.

8. A gum massager according to claim 1, wherein said elongate handle member is formed so as to facilitate attachment of said gum massager to an electrically driven oscillatory device such that said oscillatory device provides an oscillatory movement to said massaging head member.

9. A gum massager according to claim 1, wherein said resilient massaging element is generally configured as a bell shape, having a recessed inner surface terminating in an outer lip.

10. A gum massager according to claim 9, wherein said outer lip element is formed having a curved outer edge.

11. A gum massager according to claim 9, wherein said bell-like resilient massaging element is divided into a predetermined number of separate segments.

12. A gum massager according to claim 9, wherein said resilient massaging element includes at least one resilient protrusion extending from said recessed inner surface so as to improve the massaging contact thereof on the gums.

13. A gum massager according to claim 12, wherein said at least one resilient protrusion includes a plurality of said protrusions.

14. A gum massager according to claim 12, wherein said at least one resilient protrusion includes at least one protrusion having a shape selected from the group which consists of:
a) cylindrical;
b) tubular; and
c) a predetermined geometric shape.

15. A gum massager according to claim 12, wherein said at least one resilient protrusion includes at least one rib disposed transversely across said recessed inner surface of said resilient massaging element.

16. A gum massager according to claim 9, wherein said outer lip element is formed so as to have a predetermined resilience thereby to provide a suction effect on the gum surface to stimulate the gums.

17. A gum massager according to claim 1, wherein said massaging head member is flexibly secured to said second end portion of said elongate handle member thereby to facilitate limited oscillation movement of said head member relative to said elongate handle member so as to cause said resilient massaging element of said massaging head member to maintain contact with the natural contours of the gum surface.
